(19) United States
(12) Patent Application Publication
(10) Pub. No.: US 2013/0149761 A1
(43) Pub. Date: Jun. 13, 2013

(54) METHOD TO RECOVER SUGARS OF PRE-TREATED LIGNOCELLULOSIC BIOMASS LIQUIDS

(71) Applicant: Milan Hronec, Bratislava (SK)

(72) Inventor: Milan Hronec, Bratislava (SK)

(73) Assignee: BETA RENEWABLES, S.P.A., Tortona (IT)

(21) Appl. No.: 13/817,861

(22) PCT Filed: Sep. 29, 2010
(86) PCT No.: PCT/IT10/00411

§ 371 Date: Feb. 20, 2013

(51) Int. Cl. C13B 20/02

(52) U.S. Cl. CPC C13B 20/02
USPC 435/161; 127/48

(57) ABSTRACT

This specification discloses a process for the removal of solids and non-sugar components from a pre-treated lignocellulosic biomass stream by the precipitation of the non-sugar components with preferably barium hydroxide or calcium hydroxide. The precipitation removes the non-sugar components and some salts, leaving the glucose and xylose and other sugars in the liquid stream for further processing.

### FIELD OF THE INVENTION

The present invention describes a process for the purification of aqueous solutions containing sugars formed as main or side-streams during physical, physico-chemical or chemical pre-treatment of lignocellulosic materials.

### BACKGROUND OF THE INVENTION

Utilization of lignocellulosic biomass for production of alternative energy source or value-added chemical products obviously requires efficient separation of cellulose, hemicellulose and lignin, which are principal building components of lignocelluloses. To remove lignin and hemicelluloses physical, physico-chemical or biological processes for pretreatment of lignocellulosic materials are used (Ye Sun and Jiayang Cheng Bioresource Technology, 83, 1-11, 2002). Pretreatment reduces cellulose crystallinity, increases the porosity of the material and improves the formation of sugars. However, the pretreatment must avoid the degradation or loss of carbohydrates and the formation of byproducts, which inhibit the subsequent hydrolysis and fermentation processes and some of the by-products can also act as catalyst poisons in subsequent hydrogenation and hydrogenolysis processes.

It is important to remember that lignocellulosic material is composed not only of five-carbon and six-carbon sugar polymers and aromatic lignin polymer. In addition, in lignocellulosic feed stocks are present also non-sugar compounds, like proteins and fatty acids/oils as well as the trace biocomponents containing sulfur or nitrogen atoms in functional groups that can incorporate much of the mineral content (D.C. Elliott et al. Applied Biochemistry and Biotechnology Vol. 113-116, p. 807, 2004).

Moreover, after pretreatment of lignocellulosic materials the formed main or side streams contain not digestible materials, e.g. water-soluble lignins attached to carbohydrates, acidic oligosaccharides carrying fewer uronic and hexenuronic acids and salts of various acids.

Some of materials present in the lignocellulosic feedstocks or streams formed during pretreatment are potential catalyst poisons. A purification of main and side stream fractions is needed when they are further processing in the presence of metal catalysts.

In the Chinese patent CN 10.16.28852 A a mother liquor containing xylose is purified by mixing it at a temperature of 30 to 80° C. with powdered activated carbon in amount of 2 to 10% with respect to the dry matter content of the sugar solution. After filtration the resulting solution of xylose mother liquor is subjected to anion/cation resin exchange.

In the process of ethanol production from sugar cane phosphoric acid is added to aqueous extract of sugars to enhance impurities removal, followed by mixing pre-heated aqueous extract with lime and subsequent removing the mud formed in a reaction between lime and phosphoric acid which during settlement drags many other impurities contained in the aqueous extract of sugars (J. C. P. Chen and C. C. Chou, Cane Sugar Handbook: A manual for cane sugar manufactures and their chemists. John Wiley and Sons, p. 1090, 1993).

Supercritical antisolvent precipitation was used for separation of xylan or mannan from hemicelluloses solutions in dimethylsulfoxide or dimethylsulfoxide/water mixtures by carbon dioxide as an antisolvent (E. Haimer et al., J. Nanomaterials, Volume 2008, Article ID 826974).

P. Katapodis et al., (Biotechnology Letters, Vol. 24, Number 17, p. 1413, 2002) applied the anion-exchange method for separation of acidic xylo-oligosaccharides from xylan hydrolysates.

D. Nabarlatz et al. (Separation and Purification Technology, Vol. 53, Issue 3, p. 235, 2007) used purification of xylo-oligosaccharides obtained by autohydrolysis of almond shells, using ultrafiltration through thin-film polymeric membranes.

Aqueous solutions of oligosaccharides of xylose and glucose and other soluble, mostly non-monomeric sugar-type compounds are usually the main components in some sidestreams formed during pretreatment of lignocellulosic materials. Their further treatment by catalytic hydrogenation or hydrogenolysis processes is influenced by the presence of organic and inorganic compounds in the streams which have a negative impact on catalyst activity and its life-time.

Despite considerable efforts, there remains a need for simple and cost-effective processes removing poisoning components from such streams without significant influence on the loss of material.

### SUMMARY OF THE INVENTION

Disclosed in this specification is a process for purifying an aqueous solution derived from lignocellulosic biomass containing at least (a) dissolved sugars and/or their oligomers, (b) lignin derived fragments, and (c) optional suspended solids wherein the process comprises the steps of
(A) mixing at least one precipitating agent into the aqueous solution to form a precipitate, and
(B) separating at least some of the precipitate from the aqueous solution.

It is further disclosed that the at least one precipitating agent be selected from the group consisting of barium and calcium compounds which may be comprised of oxides, hydroxides, carbonates, carboxylates with 1-3 carbon atoms in the molecule or their mutual mixtures. The precipitating agent may also comprise at least one barium or calcium compound in the form of a solid and/or aqueous solution.

It is also further disclosed to use a solid removal step on the aqueous solution to remove at least some of the suspended solids prior to mixing the precipitating agent into the aqueous solution.

It is further contemplated that the purified solution directly, or after a small additional treatment, successively passes into a fermentation step in which enzymes capable of converting the sugars and/or sugar oligomers in the aqueous solution to a non-sugar product are added to the aqueous solution after the precipitated solid has been removed.

Also disclosed is that an ion from the precipitating agent is recovered from the precipitated solid that has been separated from the aqueous solution and that the ion removed from the precipitated solid can be ion of barium or calcium. It is further disclosed that the sugars comprise monosaccharides containing an aldehyde and/or keto group in the molecule and the sugar oligomers comprise water soluble oligomers of glucose and/or xylose and their functionalized derivatives. It is also disclosed that the aqueous solution of the process may contain 2 to 20 weight % of water soluble sugars and/or their oligomers; 1.5 to 7 weight % of hemicelluloses and fats and oils, 0.01 to 10 weight % of 2-furfuraldehyde and 5-hydroxymethylfurfuraldehyde, 0.01 to 5 weight % of aliphatic carboxylic and/or dicarboxylic acids and/or aliphatic hydroxy- and/or keto-carboxylic acids with 1-6 carbon atoms in the molecule, and 0.01 to 1.5 weight % of inorganic salts.

It is further disclosed that the inorganic salts may be selected from the group of inorganic salts comprising sulfates, nitrates, chlorides, phosphates or carbonates of mono- and/or di- and/or tri-valent metals.

It is further disclosed that the precipitating agent comprises at least one barium or calcium compound and the at least one barium or calcium compound comprised of oxides, hydroxides, carbonates, carboxylates with 1-3 carbon atoms in the molecule or their mutual mixtures.

It is further disclosed that the precipitation occur in the temperature range of 20 to 220° C., preferably in the range of 20° C. to the boiling temperature of solution at atmospheric pressure.

### DETAILED DESCRIPTION

An object of the invention is to provide a process for the purification of an aqueous solution formed as main or as side stream during physical, physic-chemical and chemical pretreatment of lignocellulosic materials.

Lignocellulosic materials should be described as follows: apart from starch, the three major constituents in plant biomass are cellulose, hemicellulose and lignin, which are commonly referred to by the generic term lignocellulose. Polysaccharide-containing biomasses as a generic term include both starch and lignocellulosic biomasses. Therefore, some types of feedstocks for pretreatment can be plant biomass, polysaccharide containing biomass, and lignocellulosic biomass.

If the biomass is a polysaccharide-containing biomass and it is lignocellulosic, the pretreatment is often used to ensure that the structure of the lignocellulosic content is rendered more accessible to the enzymes, and at the same time the concentrations of harmful inhibitory by-products such as acetic acid, furfural and hydroxymethyl furfural remain substantially low.

Polysaccharide-containing biomasses according to the present invention include any material containing polymeric sugars e.g. in the form of starch as well as refined starch, cellulose and hemicellulose.

Relevant types of biomasses for pretreatment and subsequent precipitation according to the present invention may include biomasses derived from agricultural crops such as e.g.: starch e.g. starch containing grains and refined starch; com stover, bagasse, straw e.g. from rice, wheat, rye, oat, barley, rape, sorghum; softwood e.g. Pinus sylvestris, Pinus radiate; hardwood e.g. Salix spp. Eucalyptus spp.; tubers e.g. beet, potato; cereals from e.g. rice, wheat, rye, oat, barley, rape, sorghum and corn; waste paper, fiber fractions from biogas processing, manure, residues from oil palm processing, municipal solid waste or the like.

The lignocellulosic biomass feedstock is preferably from the family usually called grasses. The proper name is the family known as Poaceae or Gramineae in the Class Liliopsida (the monocots) of the flowering plants. Plants of this family are usually called grasses, or, to distinguish them from other graminoids, true grasses. Bamboo is also included. There are about 600 genera and some 9,000-10,000 or more species of grasses (Kew Index of World Grass Species).

Poaceae includes the staple food grains and cereal crops grown around the world, lawn and forage grasses, and bamboo. Poaceae generally have hollow stems called culms, which are plugged (solid) at intervals called nodes, the points along the culm at which leaves arise. Grass leaves are usually alternate, distichous (in one plane) or rarely spiral, and parallelveined. Each leaf is differentiated into a lower sheath which hugs the stem for a distance and a blade with margins usually entire. The leaf blades of many grasses are hardened with silica phytoliths, which helps discourage grazing animals. In some grasses (such as sword grass) this makes the edges of the grass blades sharp enough to cut human skin. A membranous appendage or fringe of hairs, called the ligule, lies at the junction between sheath and blade, preventing water or insects from penetrating into the sheath.

Grass blades grow at the base of the blade and not from elongated stem tips. This low growth point evolved in response to grazing animals and allows grasses to be grazed or mown regularly without severe damage to the plant.

Flowers of Poaceae are characteristically arranged in spikelets, each spikelet having one or more florets (the spikelets are further grouped into panicles or spikes). A spikelet consists of two (or sometimes fewer) bracts at the base, called glumes, followed by one or more florets. A floret consists of the flower surrounded by two bracts called the lemma (the external one) and the palea (the internal). The flowers are usually hermaphroditic (maize, monoecious, is an exception) and pollination is almost always anemophilous. The perianth is reduced to two scales, called lodicules, that expand and contract to spread the lemma and palea; these are generally interpreted to be modified sepals.

The fruit of Poaceae is a caryopsis in which the seed coat is fused to the fruit wall and thus, not separable from it (as in a maize kernel).

There are three general classifications of growth habit present in grasses; bunch-type (also called caespitose), stoloniferous and rhizomatous.

The success of the grasses lies in part in their morphology and growth processes, and in part in their physiological diversity. Most of the grasses divide into two physiological groups, using the C3 and C4 photosynthetic pathways for carbon fixation. The C4 grasses have a photosynthetic pathway linked to specialized Kranz leaf anatomy that particularly adapts them to hot climates and an atmosphere low in carbon dioxide.

C3 grasses are referred to as “cool season grasses” while C4 plants are considered “warm season grasses”. Grasses may be either annual or perennial. Examples of annual cool season are wheat, rye, annual bluegrass (annual meadowgrass, Poa annus and oat). Examples of perennial cool season are orchardgrass (cocksfoot, Dactylis glomerata), fescue (Festuca spp), Kentucky Bluegrass and perennial ryegrass (Lolium perenne). Examples of annual warm season are corn, sudangrass and pearl millet. Examples of Perennial Warm Season are big bluestem, indiangrass, bermudagrass and switchgrass.

One classification of the grass family recognizes twelve subfamilies: These are 1) anomochlooideae, a small lineage of broad-leaved grasses that includes two genera (Anomochloa, Streptochaeta); 2) Pharoideae, a′small lineage of grasses that includes three genera, including Pharus and Leptaspis; 3) Puelioideae a small lineage that includes the African genus Puelia; 4) Pooideae which includes wheat, barely, oats, brome-grass (Bronnus) and reed-grasses (Calamagrostis); 5) Bambusoideae which includes bamboo; 6) Ehrhartoideae, which includes rice, and wild rice; 7) Arundinoideae, which inludes the giant reed and common reed 8) Centothecoideae, a small subfamily of 11 genera that is sometimes included in Panicoideae; 9) Chloridoideae including the lovegrasses (Eragrostis, ca. 350 species, including teff), dropseeds (Sporobolus, some 160 species), finger millet (Eleusine coracana (L.) Gaertn.), and the muhly grasses (Muhlenbergia, ca. 175 species); 10) Panicoideae including panic grass, maize, sorghum, sugar cane, most millets, fonio and bluestem grasses. 11) Micrairoideae; 12) Danthoniodieae including pampas grass; with Poa which is a genus of about 500 species of grasses, native to the temperate regions of both hemispheres.

Agricultural grasses grown for their edible seeds are called cereals. Three common cereals are rice, wheat and maize (corn). Of all crops, 70% are grasses.

Sugarcane is the major source, of sugar production. Grasses are used for construction. Scaffolding made from bamboo is able to withstand typhoon force winds that would break steel scaffolding. Larger bamboos and Arundo donax have stout culms that can be used in a manner similar to timber, and grass roots stabilize the sod of sod houses. Arundo is used to make reeds for woodwind instruments, and bamboo is used for innumerable implements.

Therefore a preferred lignocellulosic biomass is selected from the group consisting of the grasses. Alternatively phrased, the preferred lignocellulosic biomass is selected from the group consisting of the plants belonging to the Poaceae or Gramineae family.

Besides liberating the carbohydrates from the biomass, the pre-treatment process sterilizes and partly dissolves the biomass and at the same time washes out potassium chloride from the lignin fraction.

In one type of pretreatment step, the feed stock of the lignocellulosic biomass material is continuously fed to a first pressurized reactor. The cellulosic biomass feed stock was treated by adding steam under pressure so as to dissolve and hydrolyze the hemi-cellulose, which is mainly C5s. The liquid stream is extracted and comprised of dissolved hemicellulose, C5s and amorphous C6s and hydrolysis byproducts, and of course some suspended solids such as lignin.

Examples of C5-sugar by-products that are typically removed in the aqueous solution include: aldehydes (HMF, furfural and formaldehyde), monomeric phenolics (vanillin and coniferylaldehyde) and acids (such as acetic acid and formic acid). It is the removal of these non-sugar components to which this discovery has use.

The aqueous sugars in the aqueous solution are usually derived from biological sources and are preferably monosaccharides containing an aldehyde or keto groups in the molecule. Examples of sugars include glucose, fructose, xylose and mannose. Preferably the sugar solutions contain oligomers of glucose and xylose which are soluble in aqueous solution; however the aqueous solution may contain a mixture of sugars and sugar oligomers. The sugar solutions are preferably 2 to 20 weight % of sugars and sugar oligomers, more preferably 5 to 15 weight %.

The process described below will purify the aqueous solution formed as main or as side stream during physical, physico-chemical or chemical pre-treatment of lignocellulosic materials.

The process is a purification process based on contacting the aqueous solution containing dissolved (a) sugars and/or their oligomers (b) hemicelluloses, fats and oils, (c) 2-furfuraldehyde and 5-hydroxymethylfurfuraldehyde, (d) aliphatic carboxylic and/or dicarboxylic acids and/or aliphatic hydroxy and/or keto-carboxylic acids, and (e) inorganic salts with
(i) a precipitating agent, preferably barium or calcium compounds or their mutual mixtures, and
(ii) separation of the formed precipitate.

The sugars comprising the aqueous solution will comprise monosaccharides containing an aldehyde and/or keto group in the sugar molecule.

The sugar oligomers in the aqueous solution may comprise at least some of the water soluble oligomers of glucose and/or xylose and their functionalized derivatives.

The aqueous solution preferably contains 2 to 20 weight % sugars and/or their oligomers.

The aqueous solution preferably contains 1.5 to 7 weight % of hemicelluloses and fats and oils.

The aqueous solution may also contain 0.01 to 10 weight % of the 2-furfuraldehyde and 5-hyrdoxymethlfurfuraldehyde.

The aliphatic carboxylic and/or dicarboxylic acids and/or aliphatic hydroxy and/or ketocarboxylic acids with 1-6 carbon atoms present in the aqueous solution are preferably in the range of 0.01 to 5 weight %.

The organic salts of the aqueous solution are preferably those selected from the group of inorganic salts comprising sulfates, nitrates, chlorides, phosphates or carbonates of mono- and/or di- and/or tri-valent metals.

What has been discovered is that certain precipitating agents, preferably barium hydroxideocta hydrate and calcium hydroxide (lime hydrate, calcium hydrate) will not precipitate the water soluble sugars (e.g. glucose, fructose, or xylose) or the oligomers of those sugars which can be found in the pre-treated lignocellulosic aqueous solution. Surprisingly, these same precipitating agents will precipitate the non-sugar and non-sugar oligomers; including the suspended solids and other components found in the pre-treated lignocellulosic aqueous solution. A preferred precipitating agent is comprised of oxides, hydroxides, carbonates, carboxylates with 1-3 carbon atoms in the molecule or their mutual mixtures of barium and/or calcium.

The precipitating agent is to have at least some degree water solubility, preferably complete water solubility. For example, barium hydroxide is at room temperature slightly water soluble and does not work well, if at all. The octa-hydrate variant is readily soluble (at room temperature about 7 wt % but at 100° C. about 90 wt %) and readily and quickly precipitates the non-sugars. Whether a precipitating agent is water soluble is readily gleaned from the literature. While barium hydroxide octa-hydrate is the preferred precipitating agent, other water soluble agents which have been found to be effective are aqueous solutions of lead compounds, bismuth compounds and cerium nitrates.

The mixing of the precipitating agent can occur in many ways. One embodiment is to dissolve the precipitating agent in water and then add the precipitating agent solution to the aqueous solution. Another embodiment is to add the precipitating agent as a solid to the aqueous solution and the precipitate will form as the precipitating agent is dissolved.

The purification process can be followed by measuring the pH of suspension, using turbidometry or nephelometry or other detection techniques available to one of ordinary skill.

The temperature of the precipitation is preferably done between the freezing point of the aqueous solution and the boiling point of the aqueous solution. A preferred range is therefore between 20° C. and the boiling point of the solution at atmospheric pressure. One skilled in the art will recognize that temperature may be varied to increase the amount of material precipitated or the amount of precipitating agent that is solubilized in the liquid phase of the aqueous solution.

The manner in which the formed precipitate is removed from the aqueous solution is readily available to one of ordinary skill in the art regarding separation of solids from liquids. Types of separation equipment are filters, centrifuges, presses, sediment tanks, froth flotation, and the like. The process is not limited to the use the previous listed equipments, but is open to any type of solid-liquid separation technique.

In one embodiment of the process, the suspended solids are at least partially removed from the aqueous solution prior to mixing the precipitating agent into the aqueous solution. This can be accomplished again, by any of the many solid separation techniques available to one of ordinary skill, and those which have not yet been discovered.

The process may further be followed by a fermentation step to convert the sugars and/or sugar oligomers in the aqueous solution to a non-sugar product, such as ethanol. This step can be described as adding enzymes which are capable of converting the sugars and/or sugar oligomers in the aqueous solution to a non-sugar product to the aqueous solution and maintaining the aqueous solution at a time and temperature sufficient for the enzyme to convert at least a portion of the sugars and/or sugar oligomers to a non-sugar product.

It is also possible to recover the metal ion of the precipitating agent in the precipitate. Once the precipitate is separated from the aqueous solution, the precipitated solid may be subjected to any one of the processes available to one of ordinary skill so as to recover the precipitating agent for re-use in the process. An example is to burn the precipitate and the solid residue or more preferably its water extract is recycled to the purification process.

### EXAMPLES

A sample of pretreated aqueous solution was obtained and the solids removed by centrifugation. From the liquid part was at 40° C. in vacuum evaporated volatile compounds (e.g. water, acetic and formic acids) and the obtained solid residue (designated as Dry mass) weighed and analyzed for the content of C, H, N, S by elemental analysis. As is seen from the results summarized in Table 1, the elemental analysis of the Dry mass has a very high content of nitrogen and the presence of sulfur.

TABLE 1
Elemental analysis of dry residues from the samples

| PARAMETER | | Sample 1 | Sample 1 rerun | Sample 2 |
|---|---|---|---|---|
| Dry Mass^{a} wt % | | 2.54 | 2.6 | 5.85 |
| Elemental analysis of | C | 39.14 | 37.68 | 36.37 |
| dry mass | H | 6.18 | 6.44 | 5.97 |
| % | N | 1.54 | 1.46 | 0.75 |
| | S | 0.15 | 0.27 | 0.00 |
| | Calc. O^{b} | 52.96 | 54.05 | 56.91 |

^{a}calculated on the liquid part of the liquid fraction
^{b}calculated by difference

Aqueous solutions of sodium, potassium and cesium hydroxides or cobalt acetate were mixed with aqueous solution but no precipitates formed. It was found out that by adding saturated aqueous solution of barium hydroxide to the aqueous solution, a brown-colored material precipitated. In the presence of calcium hydroxide a precipitate was also formed, but much higher volumes of calcium hydroxide solution are needed (solubility of calcium hydroxide in water is very low). Precipitates are also formed from the sample by adding aqueous solutions of lead, bismuth or cerium nitrates.

From 100 g of the aqueous liquid (the solid part was already separated by a centrifuge), after adding of 40 g of saturated (ca. 7 wt % solution) aqueous solution of barium hydroxide (at room temperature) and subsequent filtration, washing and drying at 40° C. in vacuum, 0.212 g of brown-colored solid material (i.e. 20.86 wt % calculated on the amount of Dry mass) was obtained.

A different sample (Sample 2) was used which had been similarly treated as the first sample. The difference being that sample 2 had been treated with activated carbon. For sample 2, 22.5 wt % of brown-colored solid material was obtained calculated on the amount of Dry mass in this sample. The elemental analysis are in Table 1.

According to the GC and HPLC analyses, the sample 1 contains acetic and formic acids. However, when these acids (as aqueous solutions) were mixed with aqueous solution of barium hydroxide, no solid precipitate was formed. It suggests that the barium precipitates are not the salts of the mentioned carboxylic acids with barium.

In the sample 1 was by the HPLC method determined the presence of a small amount of oxalic acid (0.017 wt %). Since oxalic acid with barium hydroxide forms a precipitate insoluble in water, from this amount of oxalic acid can be formed 1.67 wt % of barium salt (calculated on the amount of dry mass). However, this amount is significantly lower, than the amount of brown-colored solid material formed from the aqueous solution (20.86 wt %). Moreover, as is seen from the following part, the elemental analysis of the brown-colored solid is different from the corresponding theoretical contents of carbon in barium oxalate (theoretical: 10.57 wt % C and 28.19 wt % 0).

No solid precipitates were formed by mixing aqueous solution of barium hydroxide with aqueous solutions of vanillic acid and levulinic acid. Since the amount of acetic acid and the value of acid number of the sample are determined precisely, the majority of barium precipitate cannot be the salt with carboxylic acids.

The elemental analysis of the brown-colored material precipitated by barium hydroxide from the sample 1 shows (Table 2) that in comparison with the Dry mass, it contains a low concentration of carbon and hydrogen, but also nitrogen and a very high content of sulfur. The comparison of the contents of C, H, N and S in the Dry mass and in the barium precipitate indicates that the contents of carbon and hydrogen decrease almost proportionally by a factor about 2.3, but the content of nitrogen decreases about 3.5 times. In the solution no sulfur was detected.

The HPLC analysis of solutions purified with barium hydroxide has shown that it contains practically the same amount of glucose, xylose and their oligomers as untreated solution. However, in comparison to untreated solution decreases the amount of hemicelluloses, nitrogen containing compounds and practically are removed sulfur compounds. The positive effect of purification according to the invention also indicates the brighter brown color of the resulting solution.

TABLE 2
Elemental analysis of solid material precipitated by
barium hydroxide for Sample 1.

| Elemental analysis | Solid precipitated | |
|---|---|---|
| Wt. % | by barium Hydroxide | Dry mass^{a} |
| C | 16.42 | 39.14 |
| H | 2.65 | 6.18 |
| N | 0.45 | 1.57 |
| S | 2.39 | 0.15 |
| calc. O^{b} | — | 52.96 |

^{a}determined by evaporation of the liquid part of the sample at 40° C. in vacuum
^{b}calculated by difference

Further experiments with individual sugar compounds determined that aqueous solutions of glucose, fructose, xylose or sorbitol are not precipitated by aqueous solution of barium hydroxide. Also the barium precipitates from the sample are not the salts of the carboxylic acids.

We claim:

1-22. (canceled)

23. A process for purifying an aqueous solution derived from lignocellulosic biomass containing at least (a) dissolved sugars and/or their sugar oligomers, (b) lignin derived fragments, and (c) optional suspended solids wherein the process comprises the steps of
(A) mixing at least one precipitating agent into the aqueous solution to form a precipitate, and
(B) separating at least some of the precipitate from the aqueous solution.

24. The process of claim 23, wherein the at least one precipitating agent is selected from the group consisting of barium and calcium compounds.

25. The process according to claim 23, wherein a solid removal step is conducted on the aqueous solution to remove at least some of the suspended solids prior to mixing the precipitating agent into the aqueous solution.

26. The process according to claim 24, wherein a solid removal step is conducted on the aqueous solution to remove at least some of the suspended solids prior to mixing the precipitating agent into the aqueous solution.

27. The process according to claim 23, wherein the process further comprises a fermentation step (C1) in which enzymes capable of converting the sugars and/or sugar oligomers in the aqueous solution to a non-sugar product are added to the aqueous solution after the precipitated solid has been removed.

28. The process according to claim 24, wherein the process further comprises a fermentation step (C1) in which enzymes capable of converting the sugars and/or sugar oligomers in the aqueous solution to a non-sugar product are added to the aqueous solution after the precipitated solid has been removed.

29. The process according to claim 28 further comprising a recovery step (C2) wherein an ion from the precipitating agent is removed from the precipitated solid that has been separated from the aqueous solution.

30. The process according to claim 29, wherein the ion removed from the precipitated solid is an ion of barium or calcium.

31. The process of claim 23, wherein the sugars comprise monosaccharides containing an aldehyde and or keto group in the molecule.

32. The process of claim 24, wherein the sugars comprise monosaccharides containing an aldehyde and or keto group in the molecule.

33. The process of claim 23, wherein the sugar oligomers comprise water soluble oligomers of glucose and/or xylose and their functionalized derivatives.

34. The process of claim 24, wherein the sugar oligomers comprise water soluble oligomers of glucose and/or xylose and their functionalized derivatives.

35. The process of claim 23, wherein the aqueous solution contains 2 to 20 weight % of water soluble sugars and/or their oligomers.

36. The process according to claim 23, wherein the aqueous solution further comprises hemicelluloses, fats and oils.

37. The process according to claim 23, wherein the aqueous solution further comprises 2-furfuraldehyde and 5-hydroxymethylfurfuraldehyde.

38. The process according to claim 23, wherein the aqueous solution further comprises aliphatic carboxylic and/or dicarboxylic acids and/or aliphatic hydroxy and/or keto-carboxylic acids.

39. The process of claim 36, wherein the aqueous solution contains 1.5 to 7 weight % of hemicelluloses and fats and oils.

40. The process of claim 37, wherein the aqueous solution contains 0.01 to 10 weight % of 2-furfuraldehyde and 5-hydroxymethylfurfuraldehyde.

41. The process of claim 38, wherein the aqueous solution contains 0.01 to 5 weight % of aliphatic carboxylic and/or dicarboxylic acids and/or aliphatic hydroxy- and/or keto-carboxylic acids with 1-6 carbon atoms in the molecule.

42. The process of claim 23, wherein the aqueous solution further comprises inorganic salts.

43. The process of claim 42, wherein the aqueous solution comprises 0.01 to 1.5 weight % of inorganic salts.

44. The process of claim 23, wherein the aqueous solution contains inorganic salts selected from the group of inorganic salts comprising sulfates, nitrates, chlorides, phosphates or carbonates of mono- and/or di- and/or tri-valent metals.

45. The process of claim 23, wherein the precipitating agent comprises at least one barium or calcium compound and the at least one barium or calcium compound is comprised of oxides, hydroxides, carbonates, carboxylates with 1-3 carbon atoms in the molecule or their mutual mixtures.

46. The process of claim 23, wherein the precipitating agent comprises at least one barium or calcium compound in the form of a solid and/or aqueous solution.

47. The process of claim 23, wherein the temperature of an aqueous solution derived from lignocellulosic biomass is in the range of 20 to 220° C.

48. The process of claim 23, wherein the temperature of the aqueous solution is in the range of 20° C. to the boiling temperature of the aqueous solution at atmospheric pressure.
